(19) United States
(12) Patent Application Publication
(10) Pub. No.: US 2015/0146824 A1
(43) Pub. Date: May 28, 2015

(54) INDEXED I/O SYMBOL COMMUNICATIONS

(71) Applicant: Seagate Technology LLC, Cupertino, CA (US)

(72) Inventor: Nicholas Paul Mati, Longmont, CO (US)

(73) Assignee: Seagate Technology LLC, Cupertino, CA (US)

(21) Appl. No.: 14/090,332

(22) Filed: Nov. 26, 2013

(51) Int. Cl. H04L 25/08; H04B 3/46

(52) U.S. Cl. CPC H04L 25/085; H04B 3/46
USPC 375/340

(57) ABSTRACT

One implementation of the disclosed technology involves detecting a transition in a signal received via one of a first indexed input and a second indexed input. The transition defines a first symbol having a symbol value. This implementation further involves outputting the first symbol in response to detection of a transition. The symbol value of the first symbol is designated by the index of the indexed input upon which the transition is detected.

### SUMMARY

Implementations described and claimed herein address various problems by facilitating a signaling protocol that does not use a clock signal or a phase locked loop (PLL) to receive and decode symbol data. In accordance with one implementation, a method detects a transition in a signal received via one of a first indexed input and a second indexed input, the transition defining a first symbol having a symbol value. The first symbol is then output, in response to the operation of detecting the transition. The symbol value of the first symbol is designated by the index of the indexed input upon which the transition is detected.

In accordance with another implementation, a signal transition detector circuit is configured to detect a transition in a signal received via one of a first indexed input and a second indexed input. The transition defines a first symbol having a symbol value. A symbol generator circuit is coupled with the signal transition detector and is configured to output the first symbol in response to detection of the transition. The symbol value of the first symbol is designated by the index of the indexed input upon which the transition is detected.

In accordance with another implementation, a method outputs a transition in a signal via one of a first indexed output or a second indexed output. The transition defines a first symbol having a symbol value designated by the index of the indexed output via which the transition is output.

Other implementations are also described and recited herein.

### BRIEF DESCRIPTION OF THE DRAWINGS

FIG. 1 illustrates an example system for communicating symbol data from a transmitter circuit to a receiver circuit.

FIG. 2 illustrates example waveforms that can be used to signal a sequence of symbols, such as “1's” and “0's”, between a transmitter circuit and a receiver circuit.

FIG. 3 illustrates an example transmitter circuit electrically coupled with a receiver circuit.

FIG. 4 illustrates an example receiver circuit in accordance with one implementation.

FIG. 5 is an example of a clock recovery signal at a receiver in accordance with one implementation.

FIG. 6 illustrates example operations of a method performed by a transmitter circuit in accordance with one implementation.

FIG. 7 illustrates example operations of a method performed by a receiver circuit in accordance with one implementation.

### DETAILED DESCRIPTION

Communication systems often send and receive signals via signaling protocols. In order to transmit and receive data, a clock signal is often used as part of a signaling protocol to synchronize data between a transmitter and a receiver. The clock signal signals the receiver that a new bit of data is available to be read from a data input line. However, a clock signal typically consumes an input pin in an environment in which available pins are becoming increasingly scarce and valuable resources. Moreover, every time a clock signal transitions from one state to another state (e.g., from a low state to a high state or from a high state to a low state), a small amount of radio frequency interference is created. This radio frequency interference can interfere with the operation of a circuit, such as the reception of data at a receiver circuit.

When a clock signal is used as part of a signaling protocol to receive data, the clock signal also influences the speed at which the data can be communicated from a transmitter to a receiver. For example, in the case of a periodic clock signal operating as a square wave, new data bits on a data bus can be clocked into a receiver on every rising edge of the clock signal. The clock signal will then transition low before transitioning high again. The time period between the point where the clock signal transitions low and the point where the clock signal subsequently transitions high can be considered an unused period of time in the signaling protocol. This unused period of time delays message throughput. Moreover, no information is conveyed by the clock signal itself The clock signal merely synchronizes the transfer of data without supplying any data via the clock signal itself.

The disclosed technology utilizes a signaling protocol that does not employ the transmission of a clock signal to a receiver circuit. Moreover, a phase locked loop (which adds complexity and system cost) need not be employed by the receiver circuit. The omission of a clock signal can provide efficiencies that are not possible even with some double data rate (DDR) systems. DDR systems utilize both the rising edge and falling edge of a clock signal to synchronize data.

For example, one implementation of the disclosed technology provides two data lines, although more than two data lines may be employed in other implementations. The first data line is associated with or indexed as the symbol “1” while the second data line is associated with or indexed as the symbol “0.” Any transition, e.g., from low to high or high to low, on the first data line indicates the transmission/receipt of a binary “1” value. Any transition, e.g., from low to high or high to low, on the second data line indicates the transmission/receipt of a binary “0” value. As each transition occurs on the two data lines, the receiver circuit translates the successive transitions into corresponding “1's” and/or “0's” in the order that the transitions are detected on each data line. Thus, a sequence of “1's” and “0's” can be transmitted and received using two data lines without requiring the transmission of a clock signal to the receiver circuit or the use of a PLL at the receiver circuit. Because the clock signal is not transmitted to the receiver circuit, drawbacks associated with the transmission of a clock signal are avoided.

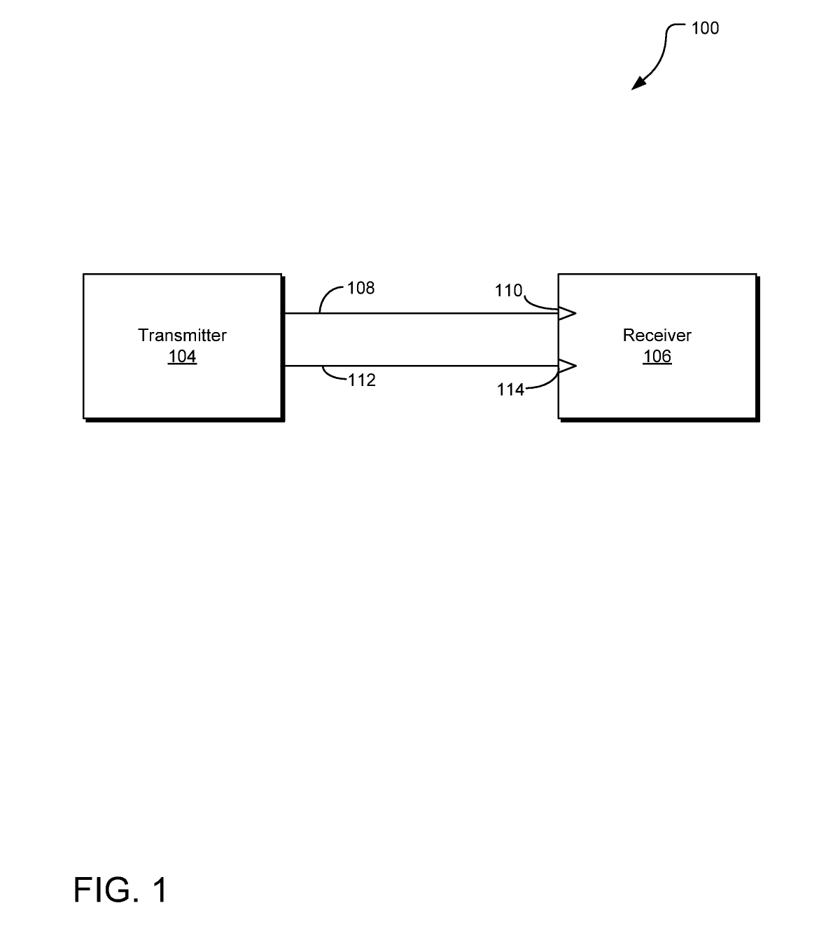

FIG. 1 illustrates an example system 100 for communicating symbol data from a transmitter circuit 104 to a receiver circuit 106. In FIG. 1, the transmitter circuit 104 is electrically coupled with the receiver circuit 106 by two data lines 108 and 112. Data line 108 is coupled with the receiver circuit via input 110. Data line 112 is coupled with the receiver circuit via input 114.

In the example of FIG. 1, data line 108 is utilized to signal a “1” symbol from the transmitter circuit to the receiver circuit. Data line 112 is utilized to signal a “0” symbol from the transmitter circuit to the receiver circuit. Each time the signal on data line 108 transitions from low to high or from high to low the receiver circuit detects a symbol value of “1.” Similarly, each time the signal on data line 112 transitions, e.g., from low to high or from high to low, the receiver circuit detects a symbol value of “0.” The inputs 110 and 114 are referred to as indexed inputs because each input is associated with a data line that signals a particular symbol value—each index corresponds to a particular symbol value.

The receiver circuit is configured to detect transitions on the data lines and to output a data stream corresponding to the detected sequence of transitions. Thus, for example, the receiver converts the received signals at inputs 110 and 114 into a binary sequence of “1's” and “0's”.

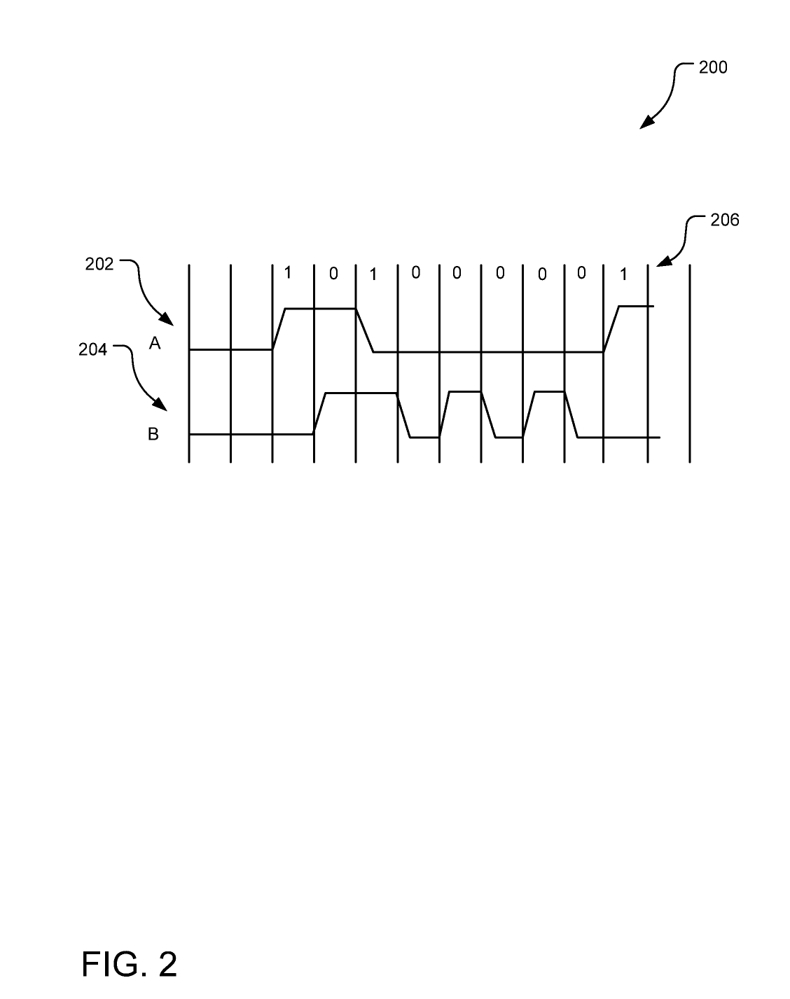

FIG. 2 illustrates example waveforms 200 that can be used to signal a sequence of symbols, such as “1's” and “0's”, between a transmitter circuit and a receiver circuit. Signal “A” 202 is a signal in which each transition of the signal corresponds to a “1” symbol. Signal “B” 204 is a signal in which each transition of the signal corresponds to the occurrence of a “0” symbol. FIG. 2 shows a value of “0” or “1” for every occurrence of a transition in either signal “A” or signal “B.” Each time a transition occurs on signal “A” a “1” is indicated above the waveforms. Each time a transition occurs on signal “B” a “0” is indicated above the waveforms—transitions do not take place at the same time for signals “A” and “B.” As can be seen in FIG. 2, the data stream 206 “1 0 1 0 0 0 0 0 1” is indicated by the transitions of signal “A” and signal “B.”

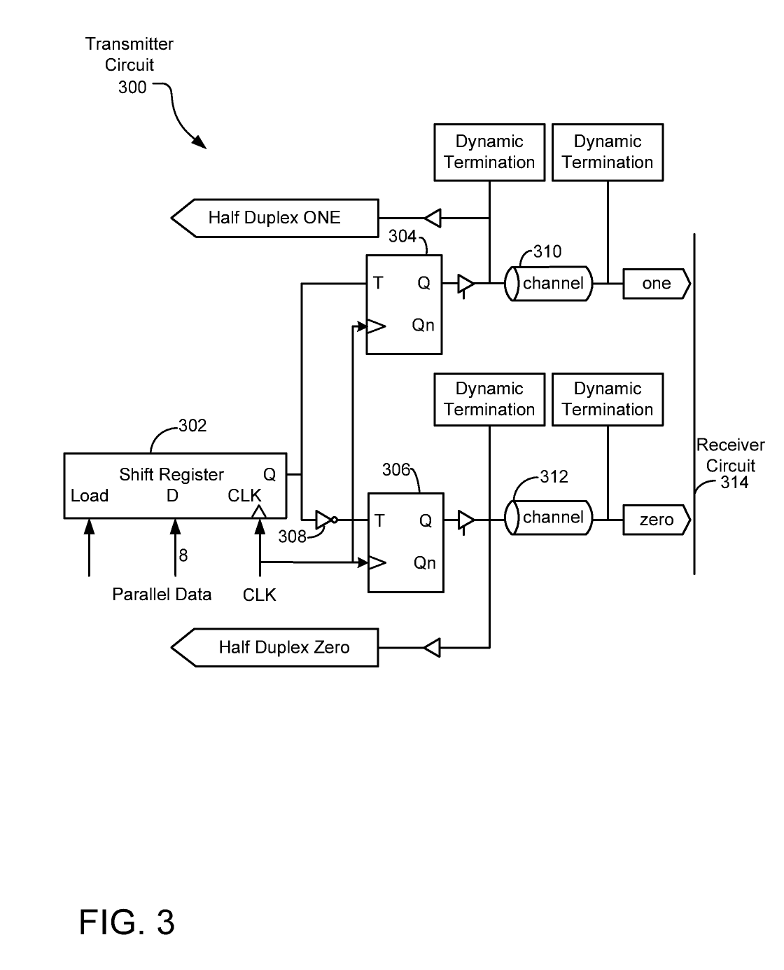

FIG. 3 illustrates an example transmitter circuit 300 electrically coupled with a receiver circuit 314. A shift register 302 is used by the transmitter circuit 300 to output a sequence of bits. The shift register 302 is first loaded with a sequence of bits corresponding to “1's” and “0's.” The shift register sequentially outputs the string of data via shift register output Q. T (toggle) flip-flop 304 receives an output bit of data from the shift register as an input on input “T.” The same output bit of data from the shift-register is inverted by inverter 308 before being applied to the input “T” of flip-flop 306. A clock signal “CLK” used locally by the transmitter circuit 300 clocks data out of the shift register and into the flip-flops 304 and 306.

Each T flip-flop operates by transitioning its output if a high signal is received (e.g., clocked-in) at the flip-flop input. Thus, whenever flip-flop 304 receives a high signal clocked-in at input T, the output from output Q is a transition from the previous state of Q. Whenever flip-flop 304 receives a low signal clocked-in at input T, the output from output Q does not change from the previous state of Q.

Thus, flip-flop 304 produces a transition change whenever the output from the shift register is a high value (e.g., a “1”). Because the output from shift register 302 is inverted by inverter 308 before being input into flip-flop 306, flip-flop 306 outputs a transition change whenever a low signal (e.g., a “0”) is output from shift register 302. Thus, for example, if the shift register outputs a low signal, the inverter 308 inverts the low signal to a high signal. When the high signal is clocked-in to input T of flip-flop 306, output Q of flip-flop 306 causes a transition from the previous state of Q. When the shift register outputs a high signal, the inverter 308 inverts the high signal into a low signal. In response to the low signal clocked-in at input T of flip-flop 306, flip-flop 306 does not cause a transition at output Q. In this manner, the combination of the shift register 302 and T flip-flops 304 and 306 serve as signal generating circuitry in the transmitter circuit 300.

The output from flip-flop 304 is transmitted across channel 310 to an indexed input on the receiver circuit 314 that is associated with a “one” signal. The output from flip-flop 306 is transmitted across channel 312 to an indexed input on the receiver circuit 314 that is associated with a “zero” signal. It should be noted that the implementation of the transmitter/receiver system shown in FIG. 3 is but one example, other configurations may also be employed.

FIG. 3 also shows dynamic terminations at the source and destination points. Such dynamic terminations could be utilized, for example, at very high signaling rates that employ low power, or for hybrid operation. The dynamic terminations also may be utilized, for example, for impedance matching.

With a circuit such as that shown in FIG. 3, the communication protocol can operate at a fast rate. The circuit does not depend on a separate clock signal sent from the transmitter to the receiver in order to synchronize the communication of data signals. Therefore, the transmission rate of the circuit is not limited by such a clock signal. Rather, the circuit can be made to perform at a greater and greater speed by improving the ability of the circuit to determine, e.g., discriminate, when a signal transitions from low to high or high to low. One manner of improving the time required to discriminate when a signal transitions is via the use of pre-compensation circuitry to reduce intersymbol interference. Such techniques can improve data rates. Also, as explained in more detail below, a clock signal can be recaptured by the receiver from the received data signals.

FIG. 3 also illustrates that a circuit can be configured as both a read/write circuit. Thus, in addition to receiving data from the shift register as part of an input operation, the receiver circuit 314 may also be configured to output data to the circuit that contains the shift register, such as a system on a chip. For such output operations by the receiver, the signal drivers reverse and the receiver circuit 314 transmits signals shown as “Half Duplex One” and “Half Duplex Zero.”

In accordance with one implementation, a transmitter and receiver system can be configured to use two data lines in either a two-wire legacy system or an indexed communication system. For example, a two-wire legacy system utilizes a clock signal on a first data line and a data signal on a second data line. The data line represents “one” or “zero” depending on whether the voltage is high or low, respectively. The same two data lines could also be used as an indexed communication system, as described herein. Thus, the same two data lines could be used by a transmitter and receiver that are configured with circuits to communicate via both a two-wire legacy system and a two-wire indexed communication system. The transmitter and receiver circuits would simply switch to the agreed communication system in order to be able to communicate—but, the same two data lines would be utilized.

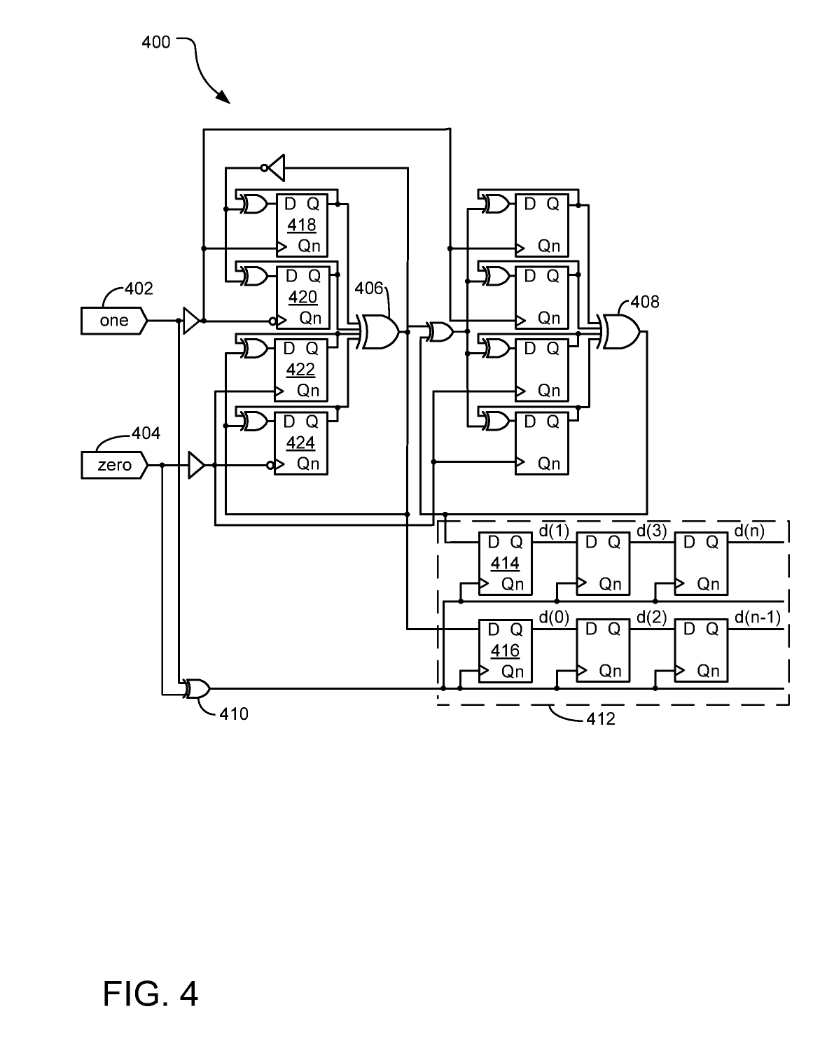

FIG. 4 illustrates an example receiver circuit 400 in accordance with one implementation. Indexed input 402 is associated with the symbol “1.” Any transition of the input signal at input 402 indicates that a symbol “1” was communicated by a transmitter circuit. Similarly, indexed input 404 is associated with the symbol “0.” Any transition of the input signal at input 404 indicates that a symbol “0” was communicated by the transmitter circuit. Because the receiver circuit 400 detects transitions, the receiver circuit 400 operates as a signal transition detector circuit.

The receiver circuit 400 in FIG. 4 utilizes a bank of exclusive-or elements and D flip-flops 418, 420, 422, and 424 to generate four inputs into exclusive-or element 406. The D flip-flops are clocked by a transition on one of the inputs. Thus, in conjunction with other portions of the circuit, the D flip-flops that generate the four inputs into the exclusive-or element 406 serve as an example signal transition detection circuit.

The D flip-flops 418 and 422 are clocked in response to an input signal having a rising edge transition. The D flip-flops 420 and 424 are clocked in response to an input signal having a falling edge transition.

The output of exclusive-or element 406 is the “Most Recent Signal” communicated via input 402 or input 404. The “Most Recent Signal” will be high if the most recent transition received is on input line 402 corresponding to the symbol “1.” The “Most Recent Signal” will be low if the most recent transition received is on input line 404 corresponding to the symbol “0.” Because the output of the exclusive-or element 406 reflects the value of the “Most Recent Signal,” the exclusive-or element 406 is an example of a symbol generator circuit.

FIG. 4 also shows a second bank of exclusive-or elements and D flip-flops for storing the “Previous Signal” communicated via input 402 or input 404. The “Previous Signal” is generated at the output of exclusive-or element 408.

In accordance with one implementation, a clock signal may be recovered from the signals received at inputs 402 and 404. Exclusive-or element 410 is used to generate the recovered clock signal. The signals on inputs 402 and 404 are routed to the inputs of exclusive-or element 410. Whenever the input signals transition such that a 1 and 0 combination or 0 and 1 combination are present at the inputs to the exclusive-or element 410, the exclusive-or element 410 will generate a high output signal. Whenever the input signals transition such that there are two low inputs at exclusive-or element 410, the exclusive-or element will generate a low output signal. It should be noted that the implementation of the receiver system shown in FIG. 3 is but one example, other configurations may also be employed.

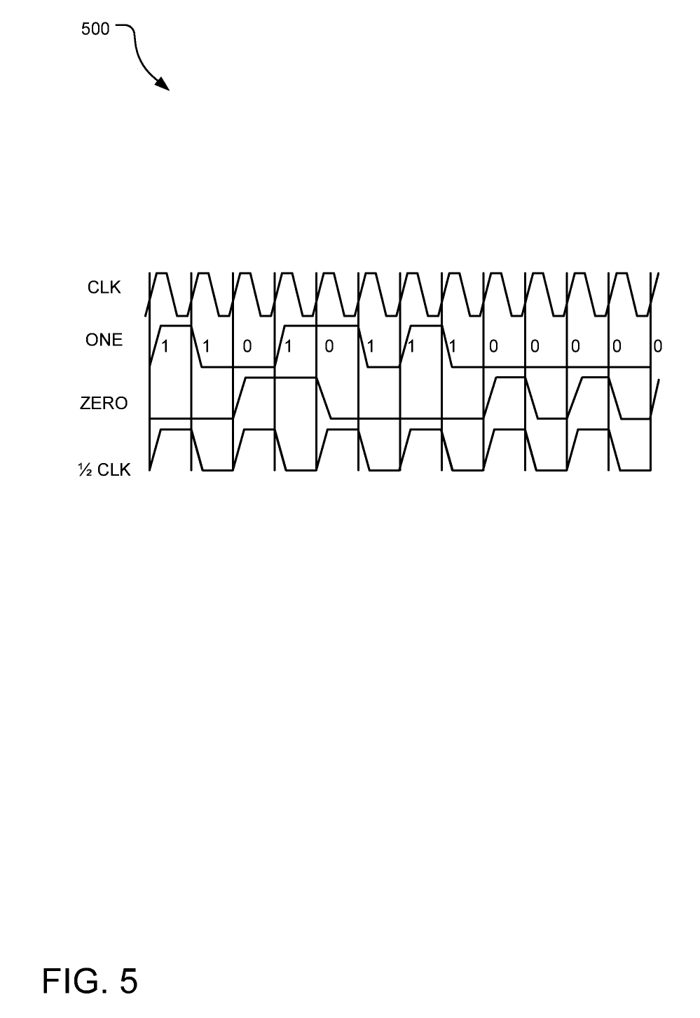

FIG. 5 illustrates an example of a clock signal recovery diagram 500. The recovered clock signal will be ½ the frequency of the clock used by the transmitter to output data from the transmitter. Thus, FIG. 5 shows the “CLK” signal used internally by a transmitter circuit. FIG. 5 also shows the transitions on the “ONE” input line and the “ZERO” input line. Finally, FIG. 5 shows the recovered clock indicated as “½ CLK.” As can be seen in FIG. 5, the “½ CLK” signal is the exclusive-or of the “ONE” and “ZERO” signals. Also, the “½ CLK” signal has one half the frequency of the “CLK” signal utilized internally by the transmitter circuit to output the “ONE” and “ZERO” signals from the transmitter.

Referring again to FIG. 4, section 412 of the receiver circuit 400 captures a string of data symbols received by the receiver circuit 400. The recovered ½ clock signal is used to store the “Previous Signal” into D flip-flop 414. The recovered ½ clock signal is used to store the “Most Recent Signal” into D flip-flop 416. Each occurrence of the ½ clock signal shifts in new values into D flip-flop 414 and D flip-flop 416. Also, each ½ clock signal shifts the outputs of the D flip-flops into the next successive pair of D flip-flops. Thus, the circuit portion 412 can be constructed to store data bits d(0) through d(n), as shown in FIG. 4.

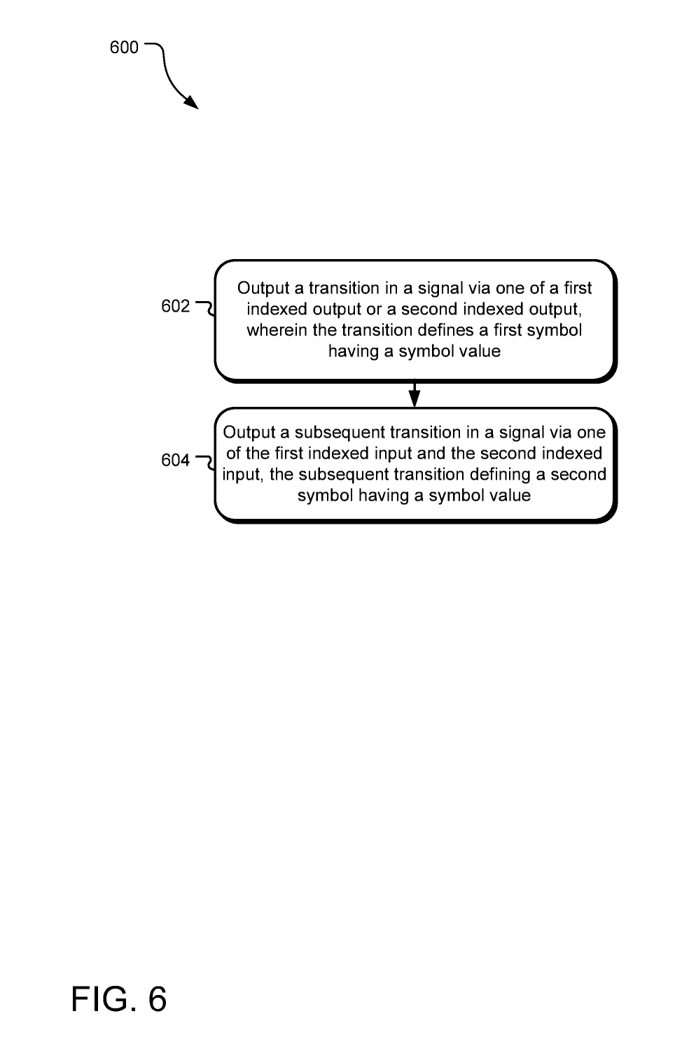

While the operation of an example of a transmitter circuit has been described above at a system level, a transmitter circuit can also be understood by the method that the transmitter circuit performs. FIG. 6 illustrates example operations 600 of a method performed by a transmitter circuit in accordance with one implementation. An output operation 602 outputs a signal transition by a transmitter on one of the transmitter's output lines. These output lines are considered indexed outputs because each output line is associated with a particular symbol. A signal transition on one of the output lines signals that a first symbol associated with that index is being communicated. Thus, for example, if a signal on the output line associated with the symbol “1” transitions from high to low or from low to high, the transmitter is transmitting a signal to indicate a “1.” Similarly, if a signal on the output line associated with the symbol “0” transitions from high to low or from low to high, the transmitter is transmitting a signal to indicate a “0.” The transition effectively defines the first symbol value because the output line is associated with the symbol value.

Another output operation 604 transmits a subsequent transition. This subsequent transition immediately follows the previous transition in time (although not necessarily on the same output line). This subsequent transition defines a second symbol having a symbol value. The symbol value of the second symbol is designated by the index of the output line on which the subsequent transition was detected.

An output line can experience multiple transitions in a row. Multiple transitions can occur on the same output line without an intervening transition on another input line. Transitions can also occur on different output lines but in temporal order.

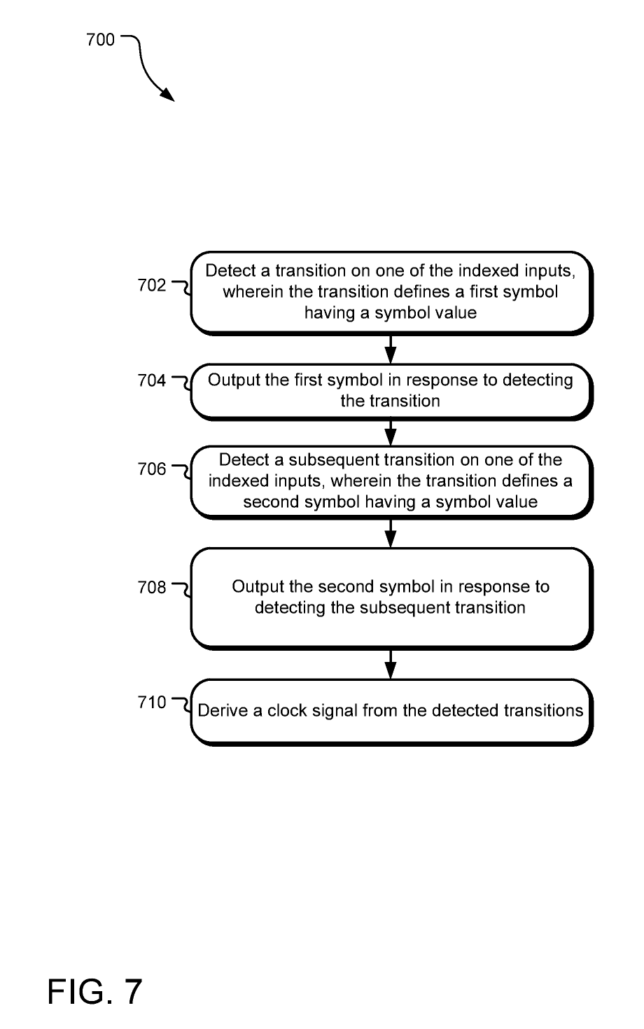

While the operation of an example of a receiver circuit has been described above at a system level, a receiver circuit can also be understood by the method that the receiver circuit performs. FIG. 7 illustrates example operations 700 of a method performed by a receiver circuit in accordance with one implementation. A detection operation 702 detects a transition on one of the indexed inputs of the receiver circuit. The receiver inputs are considered indexed because each input is associated with a particular symbol. Whenever a signal transition occurs at a particular indexed input, that transition signals to the receiver circuit the communication of the symbol associated with that index. An output operation 704 outputs the first symbol in response to detecting the transition. Thus, if a transition is detected on the input line associated with the symbol “1,” the receiver outputs a “1” or another signal representative of a “1.” The symbol value of this first symbol is designated by the indexed input upon which the transition is detected.

Another detection operation 706 detects a subsequent transition on one of the indexed inputs. This subsequent transition defines a second symbol having a symbol value. The second symbol is designated by the indexed input upon which the subsequent transition is detected. Another output operation 708 outputs the second symbol in response to the detection of the subsequent transition.

The input signals detected by the receiver circuit can be multiple transitions occurring on the same indexed inputs. For example, multiple transitions occurring on the input associated with the symbol “1” will indicate a corresponding sequence of “1's.” In addition, the input signals detected by the receiver circuit can be transitions that occur in temporal sequence but on different indexed inputs.

A derivation operation 710 derives a clock signal from the detected transitions. As noted above, an exclusive-or gate can receive the signals from the indexed inputs and generate a clock signal as an output. This clock signal is considered a half-cycle clock signal because it has half the frequency of the clock used by the transmitter circuit to output the signals that serve as inputs to the receiver circuit.

It should be appreciated that the use of this signaling protocol can reduce the total number of transitions that are employed to communicate data. Because the number of transitions is reduced, the spectral energy and radio frequency interference associated with those transitions is also reduced. This allows for improved transmission quality across low power and bandwidth limited channels. For example, double data rate (DDR) transmission schemes are presently implemented. In addition to the transitions of the data signal itself, a DDR system relies on many transitions of the clock signal as well. Referring to FIG. 5, one can see that eliminating the clock signal (CLK) would eliminate a significant amount of transitions. In FIG. 5 the transmission and reception of two bits of data is based on simply two edge transitions. In contrast, a DDR scheme with one data line and one clock employs the transmission and discrimination of four signal edges to receive two bits of data.

For example, transmitting two bits of data on a 2 wire DDR interface using one clock line and one data line utilizes four resolution events to communicate two data bits (e.g., data bit #1 arrival, first clock arrival, data bit #2 arrival, second clock arrival). Moreover, the DDR receiver would need to be pre-configured to recognize the order of arrival of signal edges.

Thus, the speed of a DDR receiver is determined by being able to deliver signal edges to the receiver and for the receiver to be able to determine the arrival order.

A two-wire indexed signaling protocol in accordance with one implementation of the present technology need utilize one half the number of resolution events as that of a two-wire DDR protocol. This is due to the fact that the two-wire indexed signaling protocol does not require a clock signal. Assuming that the number of resolution events is the key metric in determining the speed of a communication protocol, a two-wire indexed protocol would be considered to be twice as fast as a two-wire DDR protocol.

Moreover, spectral power density is often a relevant way of assessing a communication protocol. A two-wire indexed signaling protocol in accordance with one implementation of the present technology has ⅔ the spectral power density of a DDR protocol. Thus, less power is required by the two-wire indexed signaling protocol in comparison to a DDR protocol.

The implementations of the technology described herein can be implemented as logical steps in one or more computer systems. The logical operations of the present technology can be implemented (1) as a sequence of processor-implemented steps executing in one or more computer systems and/or (2) as interconnected machine or circuit modules within one or more computer systems. Implementation is a matter of choice, dependent on the performance requirements of the computer system implementing the technology. Accordingly, the logical operations of the technology described herein are referred to variously as operations, steps, objects, or modules. Furthermore, it should be understood that logical operations may be performed in any order, unless explicitly claimed otherwise or unless a specific order is inherently necessitated by the claim language.

While a transmitter and receiver are taught above using discrete circuit elements, it should be understood that the transmitter circuit and/or receiver circuit can be processor based circuits. Data storage and/or memory may be embodied by various types of storage, such as hard disc media, a storage array containing multiple storage devices, optical media, solid-state drive technology, ROM, RAM, and other technology. The operations may be implemented in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

The above specification, examples, and data provide a complete description of the structure and use of illustrative implementations of the technology. Since many implementations of the technology can be made without departing from the spirit and scope of the technology, the invention resides in the claims hereinafter appended. Furthermore, structural features of the different implementations may be combined in yet another implementation without departing from the recited claims.

What is claimed is:

1. A method comprising:
detecting a transition in a signal received via one of a first indexed input and a second indexed input, the transition defining a first symbol having a symbol value; and
outputting the first symbol, responsive to the operation of detecting the transition, the symbol value of the first symbol being designated by the index of the indexed input upon which the transition is detected.

2. The method of claim 1 further comprising:
detecting a subsequent transition in a signal received via one of the first indexed input and the second indexed input, the subsequent transition defining a second symbol having a symbol value; and
outputting the second symbol, responsive to the operation of detecting the subsequent transition, the symbol value of the second symbol being designated by the index of the indexed input upon which the subsequent transition is detected.

3. The method of claim 2 wherein the transition and the subsequent transition are detected at the same indexed input and the symbol values of the first and second symbol are identical.

4. The method of claim 2 wherein the transition and the subsequent transition are detected at different indexed inputs and the symbol values of the first and second symbol are different.

5. The method of claim 2 further comprising:
deriving a half-cycle clock signal from the detected transitions.

6. A device comprising:
signal transition detector circuitry that detects a transition in a signal received via one of a first indexed input and a second indexed input, the transition defining a first symbol having a symbol value; and
symbol generator circuitry coupled to the signal transition detector and that outputs the first symbol, responsive to detection of the transition, the symbol value of the first symbol being designated by the index of the indexed input upon which the transition is detected.

7. The device of claim 6 wherein the signal transition detector circuitry further detects a subsequent transition in a signal received via one of the first indexed input and the second indexed input, the subsequent transition defining a second symbol having a symbol value, and the symbol generator circuitry outputs the second symbol, responsive to detection of the subsequent transition, the symbol value of the second symbol being designated by the index of the indexed input upon which the subsequent transition is detected.

8. The device of claim 7 wherein the transition and the subsequent transition are detected at the same indexed input and the symbol values of the first and second symbol are identical.

9. The device of claim 7 wherein the transition and the subsequent transition are detected at different indexed inputs and the symbol values of the first and second symbol are different.

10. The device of claim 7 further comprising:
clock generating circuitry coupled to the signal transition detector circuitry and the symbol generator circuitry that derives a half-cycle clock signal from the detected transitions.

11. A method comprising:
outputting a transition in a signal via one of a first indexed output or a second indexed output, the transition defining a first symbol having a symbol value designated by the index of the indexed output via which the transition is output.

12. The method of claim 11 further comprising:
outputting a subsequent transition in a signal via one of the first indexed output and the second indexed output, the subsequent transition defining a second symbol having a symbol value, the symbol value of the second symbol being designated by the index of the indexed output upon which the subsequent transition is output.

13. The method of claim 12 wherein the transition and the subsequent transition are output at the same indexed output and the symbol values of the first and second symbol are identical.

14. The method of claim 12 wherein the transition and the subsequent transition are output at different indexed outputs and the symbol values of the first and second symbol are different.

15. A device comprising:
signal generating circuitry that outputs a transition in a signal via one of a first indexed output or a second indexed output, the transition defining a first symbol having a symbol value designated by the index of the indexed output via which the transition is output.

16. The device of claim 15 wherein the signal generating circuitry further outputs a subsequent transition in a signal via one of the first indexed input and the second indexed input, the subsequent transition defining a second symbol having a symbol value, the symbol value of the second symbol being designated by the index of the indexed output upon which the subsequent transition is output.

17. The device of claim 16 wherein the transition and the subsequent transition are detected at the same indexed input and the symbol values of the first and second symbol are identical.

18. The device of claim 16 wherein the transition and the subsequent transition are detected at different indexed inputs and the symbol values of the first and second symbol are different.
